(19) United States
(12) Patent Application Publication
(10) Pub. No.: US 2019/0116727 A1
(43) Pub. Date: Apr. 25, 2019

(54) Hack n Rake Manual Landscape Tool

(71) Applicant: Terrie Lynn St. Michel, Tempe, AZ (US)

(72) Inventor: Terrie Lynn St. Michel, Tempe, AZ (US)

(21) Appl. No.: 15/791,389

(22) Filed: Oct. 23, 2017

(51) Int. Cl. A01D 11/06; A01D 7/02; A01B 1/10

(52) U.S. Cl. CPC A01D 11/06; A01B 1/10; A01D 7/02

(57) ABSTRACT

A raking, chopping, and digging tool is disclosed which comprises a front delivery raking means mounted on a frame with extending side delivery chopping/digging mechanisms—one on each side of different widths for performing a variety of tasks—and an appropriate length and circumference sized elongated handle. Providing two substantial chopping/digging blades protruding from opposite sides of the raking frame, while also having multiple tines projecting at an optimum angle, this landscape tool offers users easy transitions between yard maintenance functions.

### CROSS-REFERENCES TO RELATED APPLICATIONS

U.S. Patent Documents

| | | |
|---|---|---|
| 4,157,119 | June 1979 | Litchfield |
| 4,167,217 | September 1979 | Tarantino |
| 4,334,583 | June 1982 | Parker |
| 4,476,939 | October 1984 | Wallace |
| 4,483,133 | November 1984 | Pasley |
| 4,901,801 | February 1990 | Popivalo |
| 5,003,760 | April 1991 | Webb |
| 5,142,855 | September 1992 | Guidarelli |
| 5,440,869 | August 1995 | Meehan |
| 5,775,080 | July 1998 | Reithel |
| 7,134,263 | November 2006 | Tedesco |
| 8,820,042 | September 2014 | Timson |

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The present invention pertains to raking devices, and more particularly pertains to devices employed for raking, chopping, and/or digging with this efficient handheld tool. This invention is designed for use by a single individual to rake loose debris/vegetation, chop weeds/vegetation, and/or dig trenches and loosen semi-hard soils with one tool. The one-piece forged raking, chopping, and digging portions of the rake are designed to allow the user to change between tasks, that is, raking, chopping, or digging, without having to use alternate tools. A simple twist of the handle—turning the tool 90 degrees—from a horizontal position to a vertical position in either direction—clockwise or counterclockwise—will allow easy and efficient transitions between desired tasks; raking, chopping, or digging.

Proper maintenance of land requires the removal of loose vegetation (e.g., leaves, twigs, pinecones, etc.) and trash (i.e., non-organic items such as paper, plastics, glass, etc.). Not only should loose vegetation and trash be removed from the upper surface of landscapes, but the removal of weeds and unwanted grasses and starter plants from below ground level should also be addressed. These conditions for landscape maintenance is oftentimes a requirement of homeowners' associations and other property and city regulations; therefore, easy upkeep is paramount for those living in shared property complexes such as: RV parks, retirement communities, family living residences, and neighborhoods with stated property management regulations. Various yard rakes, however, do not always provide sufficiently efficient cleaning of imbedded weeds and plants, and offer no viable option for removing said impediments.

Ultimately, maintaining landscapes requires the use of a variety of tools with varying functions which can be time-consuming, inefficient, and costly. Similarly, it is also desirable to simply and expediently manipulate ground material without resorting to expensive machinery, using a multitude of tools, and/or hiring skilled labor. Additionally, oftentimes conditions exist that, previously, required extensive manipulation and treatment by more than one tool before landscape areas could be converted from rough, untidy conditions to manicured, attractive usable condition. In fact, a multitude of tools are often needed to maintain landscapes (e.g., hoes, shovels, leaf rakes, rock rakes, pick axes, etc.) and this tool, the Hack n Rake Manual Landscape Tool, offers the user a variety of options for working at surface level to easily and efficiently remove unwanted vegetation and debris as well as address below the surface impediments (e.g., detaching roots) with reasonably easy user effort while minimally disturbing the soil.

Understanding the inherent problems in landscape maintenance, others have attempted to devise combination tools for accomplishing a variety of desired results, but without focusing on the specific applications offered by this tool. Particular reference is to U.S. Pat. Nos. 4,167,217, 4,334,583, 4,476,939, 4,901,801, 5,003,760, 5,440,869, and 5,775,080. These multi-purpose garden tools feature a long handle with a “head” of varying design elements that include tines or teeth which were manipulated; additionally, some of these tools also have an assortment of “attachments” for the purpose of raking and weeding. However, the garden tools described in these patents referenced above will, inadequately, work to remove more substantial imbedded roots and below-the-surface growth while also allowing the user to rake loose impediments and debris. The prior art is limited to raking loose foliage and debris while only removing a minimum of below surface growth. Other shortcomings of the prior art will appear from the descriptions of the improved device.

Prior to this invention there has been no simple, singular manually operated tool which can be used to do any or all of the following: raking landscapes, chopping weeds and other vegetation (above ground and below surface roots), and/or digging narrow trenches and loosening semi-hard surface soil.

None of the previously designed garden tools have the two side chopping/digging components necessary to uproot stubborn weeds and other unwanted vegetation as well as loosen semi-hard soils and/or dig trenches. These are the key features of this tool—the two side chopping/digging components of differing widths which allow for efficient transitions from raking to chopping and/or digging.

This tool is especially useful in areas with mixed vegetation and landscape materials (e.g., high desert regions, mountain areas, forest landscapes, rocky areas, etc.) where there is substantial leaf fall combined with rooted vegetation such as: wild grasses, starter plants, and a variety of native weeds. In addition to raking, this tool can be readily used as an axe for chopping stubborn roots or digging narrow trenches in soft and semi-hard soils.

### BRIEF SUMMARY OF THE INVENTION

The objective of the present invention is to provide an improved apparatus for raking loose vegetation, chopping and/or digging to remove weeds and unwanted grasses and starter plants with one tool while also offering the user the option of digging narrow trenches and/or loosening semi-hard surface soils. By providing two substantial steel forged chopping/digging blades of different widths (one narrow and the other wider) on either side of the raking frame with unique tines projecting at an optimum angle therefrom, a landscape tool has been described with which an individual can easily and simply perform the functions itemized in the foregoing paragraphs. The present raking mechanism is comprised of a metal head with two side delivery chopping/digging mechanisms extending on the left and right sides, each a different width, with an appropriate length and circumference sized handle.

### BRIEF DESCRIPTION OF THE SEVERAL VIEWS OF THE DRAWINGS

FIG. 1 is a perspective view of the preferred embodiment of the Hack n Rake Manual Landscape Tool showing the new design with the two different width chopping/digging blades extending on each side (left and right).

FIG. 2 is a front view of the head of the Hack n Rake Manual Landscape Tool showing the new design with the two different width chopping/digging blades extending on each side (left and right) as shown in FIG. 1.

FIG. 3 is a top plan view of the Hack n Rake Manual Landscape Tool showing the new design with the two different width chopping/digging blades extending on each side (left and right) as shown in FIG. 1.

FIG. 4 is a horizontal, side angle down view of the Hack n Rake Manual Landscape Tool showing the new design with the two different width chopping/digging blades extending on each side (left and right) as shown in FIG. 1.

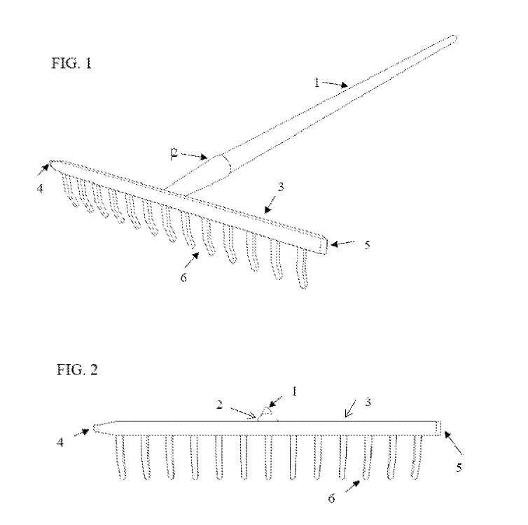

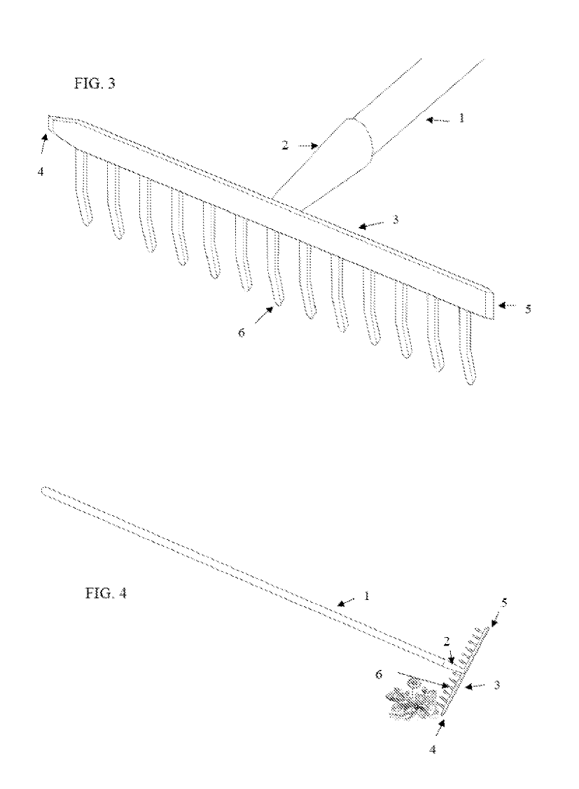

### DETAILED DESCRIPTION OF THE INVENTION

The most important features of this new invention are the two side chopping/digging blades 4 and 5. One blade is located on each side of the row of tines and can be accessed for chopping/digging by rotating the handle 1 vertically. One chopping/digging blade 5 should be approximately two-and-a-half inches in width while the opposite chopping/digging blade 4 should be approximately one inch in width. Each of these side chopping/digging components should be approximately the same length of about one-and-a-half inches long.

There should be multiple tines 4 which form the raking portion of the invention. The tines portion of the Hack n Rake Manual Landscape Tool are intended to be used for raking landscapes, loosening debris, and moving various objects.

The handle 1 is cylindrical in configuration and of heavy duty construction and can be made from a variety of composites including (but not limited to): wood, metal, or fiberglass. The handle is approximately fifty and one-half inches long, and one-and-a-half inches in diameter. A tang piece 2 at the heel of the metal head 3 provides attachment to the end of said elongated handle 1.

The metal head 3 is attached to the handle 1 with a metal tang piece 2.

What is claimed:

1. A multi-purpose yard tool for raking landscapes, chopping weeds and below-surface roots, digging narrow trenches, and/or loosening semi-soft surface soil with a head attached at one end of an elongated handle comprised of:
a. a single row of metal raking tines;
b. two side delivery chopping/digging blades protruding perpendicularly from the plane of extension of the metal raking tines, the tips of the metal raking tines extending in a direction substantially perpendicular to the edges of the chopping/digging blades from said frame with one chopping/digging blade protruding from one side and another chopping/digging blade protruding from the other side;
c. a metal head;
d. a tang piece for handle attachment;
e. an elongated handle.

2. A multi-purpose yard tool as defined in claim 1, wherein each metal raking tine tapers from its point of connection to the raking head towards its tip.

3. A multi-purpose yard tool as defined in claim 2, wherein the tips of said metal raking tines are tapered to provide structure for raking landscapes.

4. A multi-purpose yard tool as defined in claim 2, wherein each metal raking tine extends in a plane of extension and substantially parallel to the others.

5. A multi-purpose yard tool as defined in claim 2, wherein each metal raking tine is generally inclined to the axis of the elongated handle.

6. A multi-purpose yard tool as defined in claim 1, wherein one chopping/digging blade is approximately two-and-a-half inches in width while the opposite chopping/digging blade is approximately one inch in width.

7. A multi-purpose yard tool as defined in claim 6, wherein each of the side chopping/digging components is approximately the same length of about one-and-a-half inches long.

8. A multi-purpose yard tool as defined in claim 1, wherein both side delivery chopping/digging blades are approximately one-quarter of an inch thick.

9. A multi-purpose yard tool as defined in claim 1, wherein both side delivery chopping/digging blades located on each side of the metal raking tines have sharpened front edges.

10. A multi-purpose yard tool as defined in claim 1, wherein both side delivery chopping/digging blades are angled down to provide side chopping/digging surfaces.

11. A multi-purpose yard tool as defined in claim 1, wherein the left side chopping/digging blade is wide and the right side chopping/digging blade is narrow.

12. A multi-purpose yard tool as defined in claim 1, wherein the right side chopping/digging blade is wide and the left side chopping/digging blade is narrow.

13. A multi-purpose yard tool as defined in claim 1, wherein the length of the elongated handle may vary, but will extend approximately fifty and one-half inches in length for a standard version of this tool.

14. A multi-purpose yard tool as defined in claim 1, wherein the elongated handle is of medium-weight material (e.g., wood, fiberglass, aluminum, etc.).

15. A multi-purpose yard tool as defined in claim 1, wherein the head part is of solid forged-steel construction.

16. A multi-purpose yard tool as defined in claim 15, wherein the head part is about sixteen inches in length.

17. A multi-purpose yard tool as defined in claim 1, wherein the total length of the tool is approximately fifty inches in length.
